(19) United States
(12) Patent Application Publication
(10) Pub. No.: US 2026/0042091 A1
(43) Pub. Date: Feb. 12, 2026

(54) TEST PREPROCESSING CONTAINER NOZZLE, TEST KIT, AND SPECIMEN PROCESSING METHOD

(71) Applicant: CANON MEDICAL SYSTEMS CORPORATION, Otawara-shi (JP)

(72) Inventors: Satoshi YAMANE, Nasushiobara (JP); Shiori SUZUKI, Nasushiobara (JP); Seiko YOSHIMURA, Nasushiobara (JP)

(73) Assignee: CANON MEDICAL SYSTEMS CORPORATION, Otawara-shi (JP)

(21) Appl. No.: 19/290,459

(22) Filed: Aug. 5, 2025

(30) Foreign Application Priority Data
Aug. 6, 2024 (JP) 2024-129849

(51) Int. Cl. B01L 3/00

(52) U.S. Cl. CPC B01L 3/502; B01L 2200/025; B01L 2200/16; B01L 2300/0609; B01L 2300/0681; B01L 2400/0487

(57) ABSTRACT

A test preprocessing container nozzle includes a nozzle body and a filter, the nozzle body being configured to include a connected part and a nozzle part provided to the connected part, the connected part being connected to a test preprocessing container containing a specimen collected from a patient and a specimen processing liquid, which is a processing liquid for the specimen, the nozzle part having a communicating hole to deliver a fluid contained in the test preprocessing container, the filter being disposed in the nozzle body and configured to filter the fluid wherein the filter has a porosity of 70 percent (%) to 95%.

### CROSS-REFERENCE TO RELATED APPLICATIONS

This application is based upon and claims the benefit of priority from Japanese Patent Application No. 2024-129849, filed Aug. 6, 2024, the entire contents of which are incorporated herein by reference.

### FIELD

Embodiments described herein relate to a test preprocessing container nozzle, a test kit, and a specimen processing method.

### BACKGROUND

A rapid test reagent or kit for detection or quantification of various measurement items, such as a pathogenic infection due to viruses, bacteria, or the like, a pregnancy status, urinary glucose, and a blood sugar level, using an antigen-antibody reaction, an enzymatic reaction, or the like in a short time, for example, in several minutes to several tens of minutes has recently been developed. Examples of a substance to be detected or quantified include a pathogen structural protein, human Chorionic Gonadotropin (hCG), and a glucose in a specimen. Many of rapid test reagents do not require any special facilities and require a simple operation, and are available at low cost. For example, rapid test reagents for pregnancy detection are available at general pharmacies as Over The Counter (OTC) products. Unlike other test reagents, rapid test reagents for detection of pathogen infection are widely used not only in major hospitals and medical testing centers, but also in local hospitals and clinics. Recently, coronavirus disease test reagents are also available at general pharmacies as OTC products. Under such circumstances, the importance of rapid test reagents in the field of medicine has been increasing because appropriate treatments and measures for a patient can be started at earlier symptom stages if a specimen taken from a patient can be tested on the spot and detection of whether the patient is infected can be performed.

At present, immunoassay analysis methods, such as an immunoaggregation method and an immuno-membrane assay method, in particular, assay methods using a film, such as a nitrocellulose film, or a membrane, such as a filter, are generally known as rapid test methods. The membrane assay methods are roughly divided into a flow-through type assay method and a lateral flow type assay method. In addition, a test method that uses an optical sensor including an optical waveguide layer to detect the amount of substance to be detected in a specimen as an optical change is known. However, according to such rapid test methods, there has been an issue that in an analysis of a specimen that has been actually collected from a patient, even the specimen that does not contain an object to be detected is still detected as positive, that is, “false positive” can occur, or even the specimen that includes an object to be detected is still detected as negative, that is, “false negative” can occur. If a false positive reaction or a false negative reaction occurs during detection of a pathogenic infection, false information about a disease is provided, which may cause a delay in determining the cause and may cause a serious result, for example, more serious conditions in the disease due to inappropriate measures. Therefore, it is an extremely important issue to minimize the false positive reaction and the false negative reaction in view of the principal intended use of rapid test methods. The causes for the false positive reaction and the false negative reaction are not fully understood. However, one of the factors considered to contribute to the false positive reaction and the false negative reaction may be presence of a non-specific reaction substance contained in a specimen, or a property, such as a viscosity, derived from components of the specimen.

To solve the above-described issues, it is effective to use a method for filtering a specimen sample in advance and then carrying out an assay. The filtration eliminates substances that cause the false positive reaction and the false negative reaction in a specimen sample, whereby these substances are prevented from being mixed in an assay and preventing the false positive reaction and the false negative reaction. However, in a case of filtering a specimen sample with a filter, impurities in the specimen sample clog pores of the filter, which prevents the assay from starting. One solution to this issue is, for example, to improve the configuration of a sample filter. Use of a sample filter having a configuration in which several filters, including filters with a larger pore diameter or filters that retain particles having larger a diameter, and filters with a smaller pore diameter or filters that retain particles having a smaller diameter, are layered in this order can avoid clogging of a specimen sample to a certain degree during filtration. However, another issue arises in this case. The use of several filters layered on top of each other increases the thickness of the entire filter. If a commonly-used cellulose filter or the like is used, the filter absorbs a specimen sample, which leads to an increase in the amount of loss of the specimen sample. In particular, minimizing the amount of buffer solution and increasing the concentration of the object to be detected in the specimen sample are desirable to enhance the sensitivity. However, if the absorption by the filter is high, the amount of buffer solution needs to be increased by the amount corresponding to the absorption amount, which leads to a deterioration in the sensitivity. Further, an increase in the number of layered filters raises the possibility of an increase in the amount of the target substance to be adsorbed to the filter by the amount corresponding to the increase in the number of filters. While increasing the filtration area may be an option, the amount of buffer solution is limited, so that the filtration area cannot be increased indefinitely, which means that significant effects cannot be expected. Therefore, configuring a measurement system for a test kit is one of the important issues to achieve filtration of a specimen sample without deterioration of the sensitivity or while deterioration of the sensitivity is suppressed.

### BRIEF DESCRIPTION OF THE DRAWINGS

FIG. 1 is a diagram illustrating an external view of a test kit according to a first embodiment;

FIG. 2 is a diagram illustrating a configuration example of a test preprocessing container nozzle according to the first embodiment;

FIG. 3 is a sectional view taken in a vertical direction of the test preprocessing container nozzle illustrated in FIGS. 1 and 2;

FIG. 4 is a flowchart illustrating an example of a processing procedure for specimen processing using the test kit according to the first embodiment;

FIGS. 5A and 5B are diagrams illustrating an example of an introduction of a specimen into a test preprocessing container;

FIG. 6 is a diagram illustrating a state where the test preprocessing container nozzle according to the first embodiment is connected to the test preprocessing container.

FIG. 7 is a diagram illustrating a state where a mixture is dropped onto a test device through the test preprocessing container nozzle according to the first embodiment;

FIG. 8 is a diagram illustrating a configuration example of a test preprocessing container nozzle according to a second embodiment;

FIG. 9 is a sectional view taken in a vertical direction of the test preprocessing container nozzle illustrated in FIG. 8;

FIG. 10 is a diagram illustrating an external view of a test kit according to a third embodiment;

FIG. 11 is a flowchart illustrating a processing procedure for specimen processing using the test kit according to the third embodiment;

FIG. 12 is a diagram illustrating a state where a mixture is dropped into a storage container through the test preprocessing container nozzle according to the third embodiment;

FIG. 13 is a graph illustrating results of evaluation on the risk of occurrence of clogging due to a specimen in each of filters according to Comparative Examples 1 to 11 and Example 1;

FIG. 14 is a graph illustrating results of sensitivity/specificity evaluation;

FIG. 15 is a graph illustrating results of evaluation on the risk of occurrence of clogging due to a specimen in each filter; and

FIGS. 16A and 16B are graphs each illustrating results of evaluation on the film thickness of each filter and the risk of occurrence of clogging due to a specimen in each filter.

### DETAILED DESCRIPTION

A test preprocessing container nozzle according to embodiments includes a nozzle body and a filter. The nozzle body includes a connected part to be connected to a test preprocessing container containing a specimen collected from a patient and a specimen processing liquid, which is a processing liquid for the specimen, and a nozzle part provided to the connected part and having a communicating hole to deliver a fluid contained in the test preprocessing container. The filter is disposed inside the nozzle body and configured to filter the fluid. The filter has a porosity of 70 percent (%) to 95%.

Various embodiments will be described hereinafter with reference to the accompanying drawings.

A test preprocessing container nozzle, a test kit, and a specimen processing method according to embodiments will be described below with reference to the drawings. In the following description, constituent elements having substantially the same functions and configurations will be denoted by the same reference symbols, and a repetitive description of such elements will be given only where necessary.

### First Embodiment

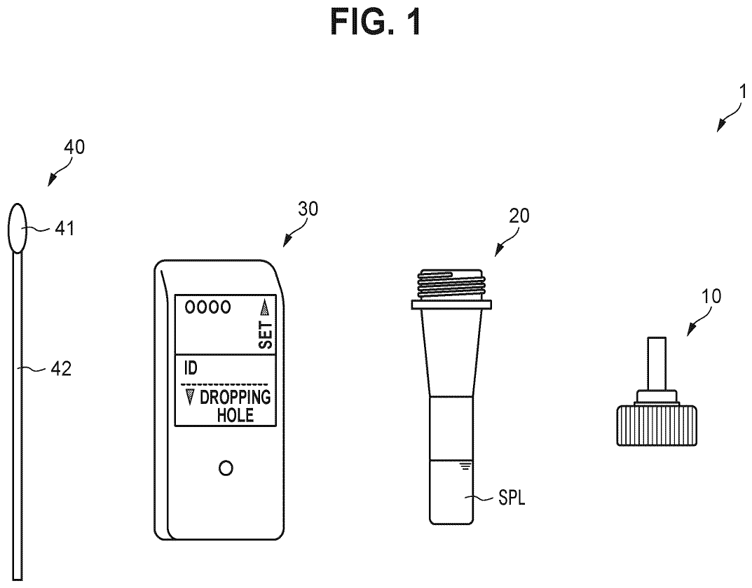

FIG. 1 illustrates a schematic view of a test kit according to a first embodiment. A test kit 1 is a kit for use in testing a substance to be tested. The substance to be tested is not particularly limited. Examples of the substance to be tested include pathogens, such as an influenza virus, an adenovirus, and a respiratory syncytial (RS) virus, and a coronavirus (COVID-19 etc.), and a part of such pathogens. As illustrated in FIG. 1, the test kit 1 according to the present embodiment includes a test preprocessing container nozzle 10, a test preprocessing container 20, a test device 30, and a specimen collection tool 40.

The test preprocessing container 20 is a container that is configured to be connectable to the test preprocessing container nozzle 10 and deformable upon application of a pressure, and contains a specimen processing liquid SPL. As the specimen processing liquid SPL, for example, a buffer solution containing surfactant is used. A specimen is suspended in the specimen processing liquid SPL. The test preprocessing container 20 is made of a material that is deformable when a pressure is applied with user's fingers. The material of the test preprocessing container 20 includes, for example, a plastic material, such as a thermoplastic resin. While there is no particular limitation on usable thermoplastic resin, examples of the thermoplastic resin include polypropylene, polyethylene, polyvinyl chloride, polyethylene terephthalate, and polystyrene. Polyethylene and polypropylene are desirable in chemical resistance and versatility, and thus are desirably used.

The test device 30 includes a substrate (hereinafter referred to as a transparent substrate) which has translucency and to which a first substance that specifically binds to a substance to be tested is fixed. The test device 30 has a dropping hole communicating with a reaction tank provided in the test device 30. The test device 30 is mounted on an optical measuring apparatus (not illustrated), and the optical measuring apparatus measures the substance to be tested. The test device 30 is also referred to as a test cartridge.

The specimen collection tool 40 is a tool to collect a specimen from a patient. The specimen collection tool 40 is, for example, a swab, a platinum loop, a dropper, or a spoon-like tool. As the specimen, pharyngeal swab, nasal swab, nasopharyngeal swab, nasal aspirate fluid, or nasal lavage fluid collected from a human or other animals may be preferably used. Alternatively, alveolar lavage fluid, blood, fecal suspension, or rectal swab collected from a human or other animals may be used. Particularly, in a case where a subject is a human and pharyngeal swab, nasal swab, nasal aspirate fluid, nasal lavage fluid, alveolar lavage fluid, fecal suspension, or rectal swab collected from the human is used as a specimen, a swab is used as the specimen collection tool 40. As illustrated in FIG. 1, the swab has a configuration in which a specimen collection part 41 is a cotton ball with cotton attached around a head part at one leading end of a shaft 42. The configuration of the swab is not limited to this example. That is, the swab may have any configuration. For example, a brush-like swab that is a swab having a configuration in which fibers made of a natural material or an artificial material are arranged in a brush form and a fluid is collected using a capillary action.

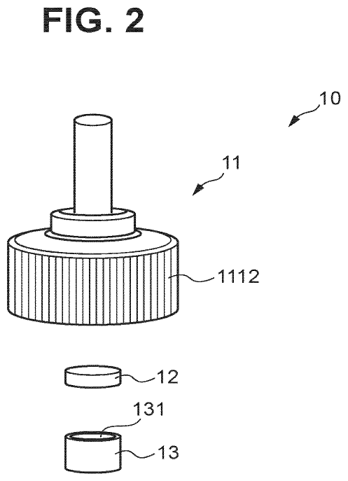

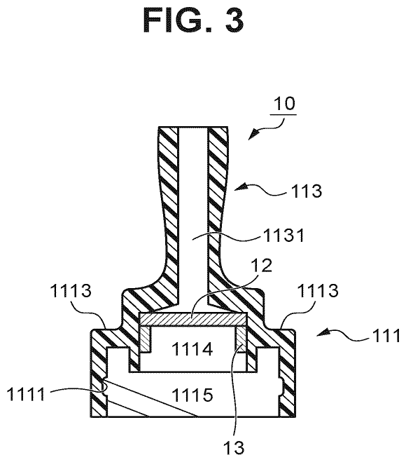

The test preprocessing container nozzle 10 is a nozzle that is connected to the test preprocessing container 20. FIG. 2 illustrates a configuration example of the test preprocessing container nozzle 10 according to the first embodiment. FIG. 3 is a sectional view taken in a vertical direction of the test preprocessing container nozzle 10 illustrated in FIGS. 1 and 2. As illustrated in FIGS. 2 and 3, the test preprocessing container nozzle 10 according to the present embodiment includes a nozzle body 11, a filter 12, and an anti-falling member 13.

As illustrated in FIG. 3, the nozzle body 11 includes a connected part 111 and a nozzle part 113. In the present embodiment, the connected part 111 and the nozzle part 113 are formed of, for example, an elastic synthetic resin, such as a low-density polyethylene. While, in the present embodiment, the nozzle part 113 is integrally formed with the connected part 111, the connected part 111 and the nozzle part 113 may be formed separately and combined together afterward. Alternatively, a user may attach the nozzle part 113 to the connected part 111 afterward.

The connected part 111 is connected to the test preprocessing container 20 that contains the specimen collected from the patient and the specimen processing liquid SPL as a processing liquid for the specimen. The connected part 111 according to the present embodiment is connected to the test preprocessing container 20 by fastening the connected part 111 to the test preprocessing container 20 by screwing. Thus, the connected part 111 has a schematically cylindrical shape and has a thread groove 1111 formed on the inside surface thereof. One or more thread grooves 1111 may be formed. In the example illustrated in FIG. 2, the outside surface of the connected part 111 has knurls 1112. The knurls 1112 are provided to prevent slippage of user's fingers when the user attaches the connected part 111 to the test preprocessing container 20. While, in the present embodiment, the knurls 1112 is provided at the outer periphery of the connected part 111 to prevent slippage of user's fingers, the configuration for preventing slippage of user's fingers is not limited to this example. That is, any configuration may be employed to prevent slippage of user's fingers. For example, a configuration may be employed in which one or more protruding parts extend from an upper part of the side surface of the connected part 111 to a lower part of the side surface so that the protruding parts protrude toward the outer periphery direction from the side surface of the connected part 111. While in the present embodiment, the configuration to prevent slippage of user's fingers is provided at the outer periphery of the connected part 111, the configuration to prevent slippage of user's fingers may be omitted.

The nozzle part 113 is provided to the connected part 111 and has a communicating hole 1131 through which a fluid contained in the test preprocessing container 20 is delivered. Specifically, as illustrated in FIGS. 2 and 3, the nozzle part 113 has a schematically cylindrical shape that is elongated with the communicating hole 1131 formed at the center part of the nozzle part 113. The outside diameter and the inside diameter of the cylindrical shape of the nozzle part 113 are respectively smaller than the outside diameter and the inside diameter of the connected part 111, and the length of the cylindrical shape of the nozzle part 113 is longer than the length (height) of the connected part 111. The nozzle part 113 is provided to an upper surface 1113 of the connected part 111 to be concentrically with the connected part 111.

The communicating hole 1131 that forms the inside diameter of the cylindrical shape of the nozzle part 113 communicates with a void that forms the inside diameter of the cylindrical shape of the connected part 111 so that the fluid from the test preprocessing container 20 smoothly flows from the void in the connected part 111 having the cylindrical shape to the communicating hole 1131 of the nozzle part 113 having the cylindrical shape.

In particular, as illustrated in FIG. 3, an upper part of the connected part 111 has a void 1114. As illustrated in FIG. 3, in the present embodiment, the filter 12 and the anti-falling member 13 are disposed in the void 1114. The connected part 111 has a void 1115 at its lower part. In the present embodiment, an upper end part of the test preprocessing container 20 is screwed into the void 1115.

As illustrated in FIG. 3, the nozzle part 113 has the communicating hole 1131 having an elongated straight shape. In other words, the fluid from the test preprocessing container 20 that has passed through the filter 12 disposed in the void 1114 passes through the communicating hole 1131 that communicates with the void 1114, and is discharged from the leading end of the nozzle part 113. In this processing, the test preprocessing container nozzle 10 and the test preprocessing container 20 are used in a state where the test preprocessing container nozzle 10 and the test preprocessing container 20 are turned over by the user from the state illustrated in FIG. 3, so that the leading end of the nozzle part 113 faces downward and the fluid is dropped onto the dropping hole of the test device 30. The amount of fluid dropped from the test preprocessing container nozzle 10 is set to be a constant amount, that is, with six drops, the amount is about 160 mg, for example.

The anti-falling member 13 is a member for preventing the filter 12 from falling. The anti-falling member 13 is formed in a cylindrical shape and has a passage hole 131 through which the fluid passes. In the case illustrated in FIG. 3, the anti-falling member 13 is fitted to the void 1114, whereby the filter 12 is disposed in the void 1114, which prevents the filter 12 from falling from the inside of the void 1114.

The filter 12 is disposed inside the nozzle body 11 and configured to filter a fluid. Specifically, the filter 12 is a filter for filtering a mixture of a specimen and a specimen processing liquid as a processing liquid for the specimen. The filter 12 has, for example, a sponge-like structure including a structure with a porous in a mesh-like network form. The filter 12 has an outside diameter of, for example, about 0.7 centimeters (cm). In the present embodiment, the filter 12 retains a reagent containing a substance that can bind to a subject to be detected in the specimen. Accordingly, the filter 12 is configured to mix the fluid with the reagent contained in the filter 12 when the mixture of the specimen and the specimen processing liquid passes through the filter 12, and to deliver the mixture to the communicating hole 1131 in the nozzle part 113.

The filter 12 desirably has a porosity of 70% to 95%, and more desirably, 74% to 91%. When the filter 12 has a porosity of 70% or more, the risk of occurrence of clogging of the filter due to the specimen is able to be prevented.

The filter 12 desirably has a pore diameter of 25 micrometers (μm) to 600 μm. When the filter 12 has a pore diameter of 25 μm to 600 μm, the risk of occurrence of clogging due to the specimen is able to be prevented.

With application of a pressure of 0.2 megapascals (MPa) to the filter 12, a change rate of a film thickness of the filter 12 before and after the application of the pressure is desirably 15% or more, and more desirably, 20% or more. With the change rate of the film thickness of the filter 12 before and after the application of the pressure is 20% or more, processing is facilitated and a degree of freedom of press-fitting into a minute flow channel is increased.

The filter 12 is a so-called depth filter that captures impurities in the specimen not only on the surface of the filter 12, but also on the inside of the filter 12. Accordingly, the filter 12 desirably have a certain thickness. For example, the film thickness of the filter 12 is desirably of 1 millimeter (mm) to 5 mm, and more desirably, 1.5 mm to 5 mm. In particular, when the film thickness of the filter 12 is 1.5 mm to 5 mm, clogging of the filter 12 due to the specimen hardly occurs, so that a certain amount of fluid is able to be dropped.

As a material of the filter 12, for example, polyvinyl alcohol, urethan, polyethylene, ethylene/polymer, or polyurethan are desirably used. The material of the filter 12 is not limited to these examples. That is, any material may be used as the material for the filter 12. As the material of the filter 12, materials other than polyvinyl alcohol, urethan, polyethylene, ethylene/polymer, or polyurethan may be used, and any combination of these materials and materials other than these materials may also be used.

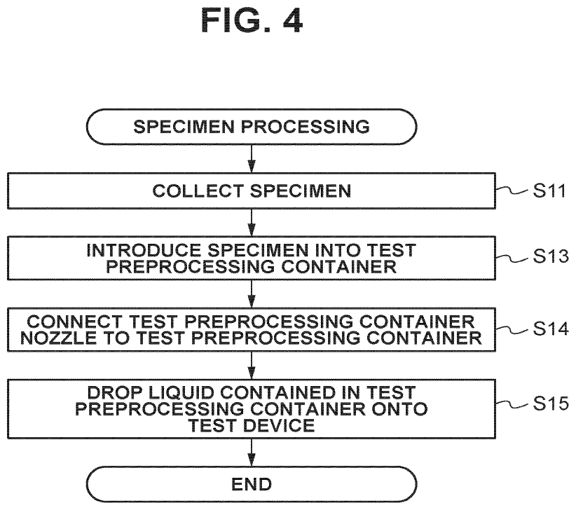

Next, a processing procedure for specimen processing using the test kit 1 according to the first embodiment will be described. FIG. 4 illustrates an example of a processing procedure for specimen processing using the test kit 1 according to the first embodiment. As illustrated in FIG. 4, first, in step S11, the user collects a specimen. Specifically, the user collects the specimen from the patient by using the specimen collection tool 40. More specifically, for example, in a case where nasal swab is used as the specimen, the user scrapes the nasopharynx using a sterilized swab which is an example of the specimen collection tool 40, whereby nasal swab is collected.

Next, as illustrated in FIG. 4, in step S13, the user introduces the specimen into the test preprocessing container 20. Specifically, the user introduces the specimen collected using the specimen collection tool 40 in step S11 into the test preprocessing container 20. More specifically, for example, in a case where nasal swab is used as the specimen, the user immerses the specimen collection tool 40 in the specimen processing liquid SPL contained in the test preprocessing container 20, whereby the specimen is introduced.

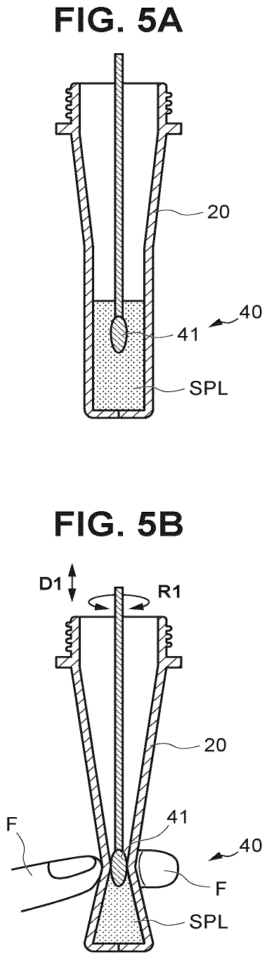

FIGS. 5A and 5B each illustrate an example of introducing the specimen into the test preprocessing container 20. As illustrated in FIG. 5A, the user immerses the specimen collection part 41 of the satirized swab as the specimen collection tool 40 with which nasal swab is collected in the specimen processing liquid SPL contained in the test preprocessing container 20. Then, as illustrated in FIG. 5B, the user applies a pressure to the test preprocessing container 20 with fingers F, and moves the sterilized swab vertically in a D1 direction and rotates the sterilized swab in an R1 direction while applying the pressure to the specimen collection part 41 within the test preprocessing container 20, whereby the specimen is extracted from the specimen collection part 41, and the specimen is introduced into the test preprocessing container 20.

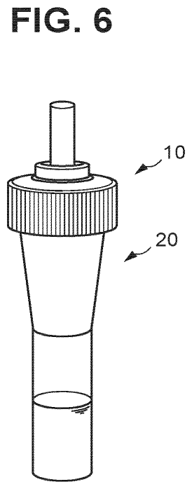

Next, as illustrated in FIG. 4, in step S14, the user connects the test preprocessing container nozzle 10 to the test preprocessing container 20. FIG. 6 illustrates a state where the test preprocessing container nozzle 10 according to the first embodiment is connected to the test preprocessing container 20. As illustrated in FIG. 6, the user fastens the test preprocessing container nozzle 10 to the upper end of the test preprocessing container 20 by screwing, whereby the test preprocessing container nozzle 10 is connected to the test preprocessing container 20.

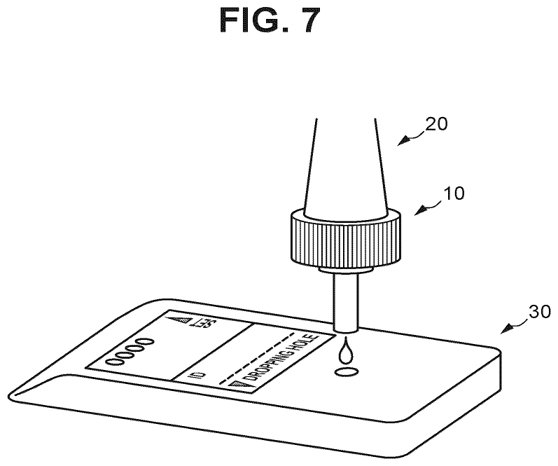

Next, as illustrated in FIG. 4, in step S15, the user drops the fluid contained in the test preprocessing container 20 onto the test device 30. Specifically, the user drops the mixture of the specimen and the specimen processing liquid SPL contained in the test preprocessing container 20 onto the test device 30. More specifically, the user applies a pressure to the test preprocessing container 20 with the fingers F, whereby the mixture is filtered through the filter 12 of the test preprocessing container nozzle 10 and the reagent retained in the filter 12 is mixed with the mixture. Then, the user drops the mixture onto the test device 30 as illustrated in FIG. 7.

After step S15 is executed, the specimen processing according to the present embodiment ends. After the execution of this step S15, the user sets the test device 30 on the optical measuring apparatus (not illustrated) and starts optical measurement processing.

As described above, the test preprocessing container nozzle 10 according to the first embodiment includes the nozzle body 11 and the filter 12, and the filter 12 disposed within the nozzle body 11 has a porosity of 70% to 95%. With this configuration, filtration of a specimen sample is achieved without deterioration of the sensitivity or while deterioration in the sensitivity is suppressed.

### Second Embodiment

In the test preprocessing container nozzle 10 according to the first embodiment described above, the filter 12 retains a reagent. However, the configuration of the test preprocessing container nozzle 10 is not limited to this example. The test preprocessing container nozzle 10 according to a second embodiment may include a reagent retaining part that retains a reagent. An embodiment in which this modified example is applied to the first embodiment will be described below as the second embodiment, and only differences between the second embodiment and the first embodiment will be described.

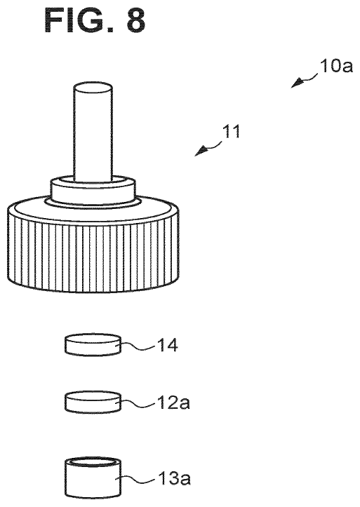

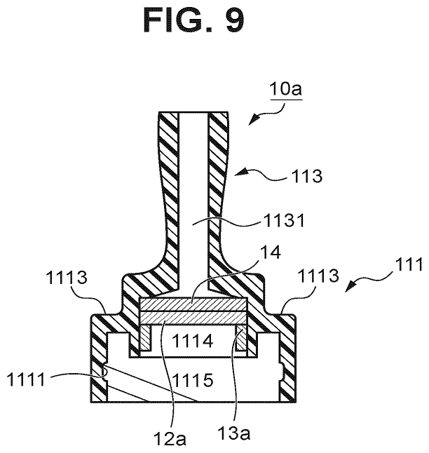

FIG. 8 illustrates a configuration example of a test preprocessing container nozzle according to the second embodiment and corresponds to FIG. 2. FIG. 9 is a sectional view taken in the vertical direction of the test preprocessing container nozzle illustrated in FIG. 8 and corresponds to FIG. 3. As illustrated in FIGS. 8 and 9, a test preprocessing container nozzle 10a according to the present embodiment includes a nozzle body 11, a filter 12a, an anti-falling member 13a, and a reagent retaining part 14. The configuration of the nozzle body 11 is similar to that of the first embodiment, and thus description thereof is omitted.

The filter 12a according to the second embodiment differs from the filter 12 according to the first embodiment in that the filter 12a is not configured to retain a reagent. The anti-falling member 13a according to the second embodiment is a member for preventing the filter 12a and the reagent retaining part 14 from falling. The other components of the filter 12a and the anti-falling member 13a are similar to those of the filter 12 and the anti-falling member 13 according to the first embodiment described above, and thus descriptions thereof are omitted.

The reagent retaining part 14 is a member for retaining a reagent containing a substance that can bind to a substance to be detected in the specimen. The reagent retaining part 14 is also referred to as a pad. As illustrated in FIG. 9, in the void 1114, the reagent retaining part 14, the filter 12a, and the anti-falling member 13 are disposed in this order from the leading end side of the nozzle part 113. Accordingly, the fluid filtered by the filter 12a is delivered to the reagent retaining part 14, and the reagent retained in the reagent retaining part 14 is mixed with the fluid filtered by the filter 12a. Then, the mixture is delivered to the communicating hole 1131 of the nozzle part 113.

The reagent retaining part 14 is a part which has been impregnated with the reagent and dried, whereby the reagent is retained. To impregnate the reagent, the reagent retaining part 14 is, for example, a porous structure having a plurality of pores formed therein. The reagent retaining part 14 according to the present embodiment is prepared using, for example, polyester, and has a thickness of 0.4 mm and a diameter of 0.7 cm. While polyester is used as a material for the reagent retaining part 14 according to the present embodiment, the material for the reagent retaining part 14 is not limited to polyester. That is, any material may be used as the material for the reagent retaining part 14. For example, any one of polypropylene, polyethylene, polystyrene, polymethyl methacrylate, alumina, zirconia, and silicon may be used. The thickness of the reagent retaining part 14 according to the present embodiment is 0.4 mm. However, the thickness of the reagent retaining part 14 is not limited to 0.4 mm. That is, the thickness of the reagent retaining part 14 may be arbitrarily set, and may be less than 0.4 mm or more than 0.4 mm.

### Third Embodiment

In the test kit 1 according to the first and second embodiments described above, a fluid containing a specimen and a specimen processing liquid is dropped onto the test device 30. In a third embodiment, a fluid containing a specimen, a specimen processing liquid, and a reagent is dropped into a storage container different from the test device 30. An embodiment in which this modified example is applied to the first embodiment will be described below as the third embodiment, and only differences between the third embodiment and the first embodiment will be described.

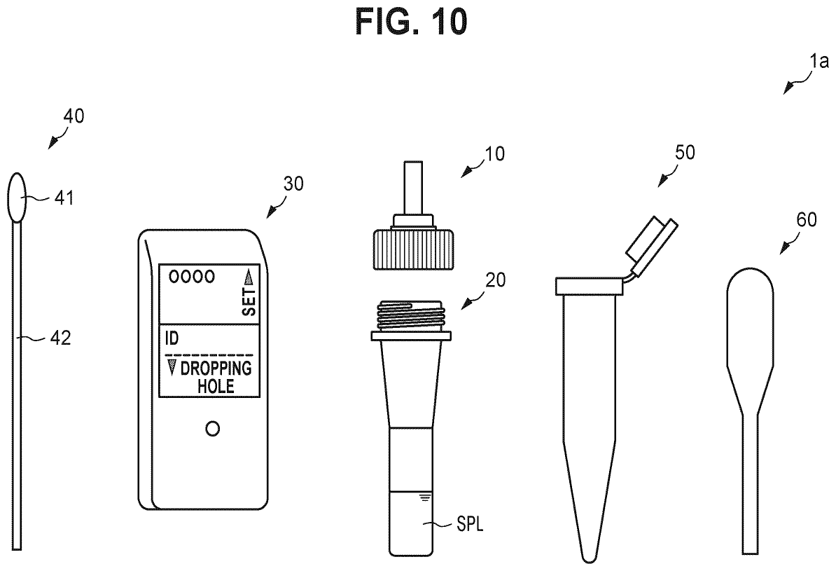

FIG. 10 is an external view of a test kit according to the third embodiment and corresponds to FIG. 1. As illustrated in FIG. 10, a test kit 1a according to the third embodiment includes a test preprocessing container nozzle 10, a test preprocessing container 20, a test device 30, a specimen collection tool 40, a storage container 50, and a dropper 60. The configurations of the test preprocessing container nozzle 10, the test preprocessing container 20, the test device 30, and the specimen collection tool 40 are similar to those illustrated in FIG. 1, and thus descriptions thereof are omitted.

The storage container 50 is a container that stores a fluid containing a specimen, a specimen processing liquid, and a reagent. Any type of container can be used as the storage container 50 as long as the container can store a fluid. However, to avoid contamination due to an outside air or the like, it may be desirable to use a lidded container. In the example illustrated in FIG. 10, the storage container 50 has a tapered shape that is tapered from an opening part to a leading end part. Examples of the container that satisfies such conditions include a microtube.

The dropper 60 is a tool for injecting the fluid stored in the storage container 50 and discharging the fluid to the test device 30. The dropper 60 is not an essential constituent element for the test kit 1a. For example, in a case where a different dropper owned by an operator is used, there is no need to include the dropper 60 in the test kit 1a.

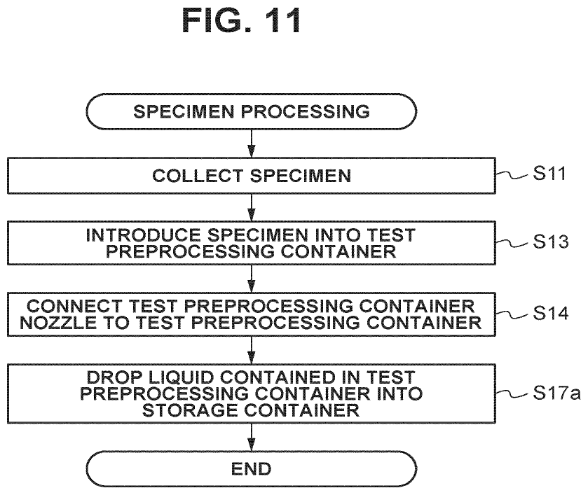

A processing procedure for specimen processing using the test kit 1a according to the third embodiment will be described with reference to FIG. 11. FIG. 11 is a flowchart illustrating an example of the processing procedure for specimen processing using the test kit 1a according to the third embodiment, and corresponds to FIG. 4. The processing of steps S11 to S14 is similar to that illustrated in FIG. 4, and thus descriptions thereof are omitted.

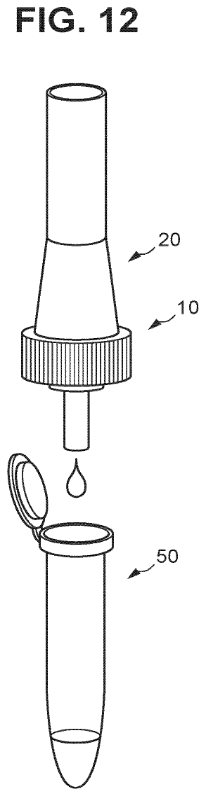

Next, as illustrated in FIG. 11, in step S17a, the user drops the fluid contained in the test preprocessing container 20 into the storage container 50. Specifically, the user drops the mixture of the specimen and the specimen processing liquid SPL contained in the test preprocessing container 20 and the reagent into the storage container 50. More specifically, the user applies a pressure to the test preprocessing container 20 with the fingers F, whereby the mixture is filtered through the filter 12 of the test preprocessing container nozzle 10, the specimen and the specimen processing liquid SPL are mixed with the reagent retained in the filter 12, the mixture is dropped into the storage container 50 as illustrated in FIG. 12.

After step S17a is executed, the specimen processing according to the present embodiment ends. After execution of this step S17a, the user leaves the dropped fluid to stand still for a predetermined period of time after dropping the fluid into the storage container 50. After the predetermined period of time, the fluid in the storage container 50 is sucked with the dropper 60 and the suctioned fluid is dropped onto the test device 30 set on the optical measuring apparatus, and then optical measurement processing is started.

### MODIFIED EXAMPLES

While the first to third embodiments described above illustrate an example where the test preprocessing container nozzle 10 and the test preprocessing container 20 are connected by fastening the test preprocessing container nozzle 10 to the test preprocessing container 20 by screwing, the method for connecting the test preprocessing container nozzle 10 and the test preprocessing container 20 is not limited to this example. That is, the test preprocessing container nozzle 10 and the test preprocessing container 20 may be connected by any connection method. For example, the test preprocessing container nozzle 10 and the test preprocessing container 20 may be connected by fitting, or may be connected by bonding.

The test preprocessing container nozzle 10 according to the first and third embodiments described above includes the anti-falling member 13, and the test preprocessing container nozzle 10a according to the second embodiment described above includes the anti-falling member 13a. However, the anti-falling members 13 and 13a may be omitted. In this case, the filter 12 and the reagent retaining part 14 of the test preprocessing container nozzle 10 according to the first and third embodiments described above and the filter 12a and the reagent retaining part 14 of the test preprocessing container nozzle 10a according to the second embodiment described above may be attached to the nozzle body 11 by bonding or the like to prevent the filters 12 and 12a and the reagent retaining part 14 from falling from the nozzle body 11.

### EXAMPLES

Examples will be described in detail below. However, the following examples do not intend to limit the present disclosure.

### [Test Example 1] Evaluation on Risk of Clogging Due to Specimen

### 1. Preparation of Filters

As illustrated in Table 1, filters according to Comparative Examples 1 to 11 and Example 1 were formed and prepared.

TABLE 1

| | Comparative | Comparative | Comparative | Comparative | Comparative | Comparative |
|---|---|---|---|---|---|---|
| No | Example 1 | Example 2 | Example 3 | Example 4 | Example 5 | Example 6 |
| Material | Cellulose | Cellulose | Cellulose | Cellulose | Cellulose | Cellulose |
| Thickness | 1.00 | 0.93 | 0.2 | 0.23 | 0.21 | 0.75 |
| (mm) | | | | | | |
| Particle | 4 | 6 | 6 | 5 | 5 | 4 |
| retention | | | | | | |
| diameter | | | | | | |
| (μm) | | | | | | |
| | Comparative | Comparative | Comparative | Comparative | Comparative | |
| No | Example 7 | Example 8 | Example 9 | Example 10 | Example 11 | Example 1 |
| Material | Cellulose | Cellulose | Cellulose | Cellulose | Cellulose | Polyvinyl |
| | | | | | | alcohol |
| Thickness | 0.25 | 0.6 | 0.27 | 0.95 | 0.8 | 2.00 |
| (mm) | | | | | | |
| Retention | 3 | 4 | 8 | 5 | 2 | 80 |
| particle | | | | | | |
| diameter | | | | | | |
| (μm) | | | | | | |

### 2. Preparation of Sample Fluid

A brush-like swab for collecting a specimen as the specimen collection tool 40 was inserted into the nasal void of a human to collect mucosal scrapings as a specimen. The weight of the brush-like swab with which the nasal mucosa specimen (pharyngeal swab) was collected was measured and the amount of the collected specimen was calculated by subtracting the original weight before collection from the measured weight. The specimen processing liquid SPL was prepared by dispensing 550 microliters (μL) into each test preprocessing container 20 connectable to the test preprocessing container nozzle 10 including the filter, and a cotton ball part corresponding to the specimen collection part 41 of the brush-like swab with which the nasal mucosa specimen was collected was immersed in the specimen processing liquid SPL. The cotton ball part of the brush-like swab is pinched through a tube, and the brush-like swab was pulled out while the cotton ball part was squeezed about ten times. The mixture of the obtained nasal mucosa specimen and the specimen processing liquid SPL is hereinafter referred to as a sample fluid.

### 3. Evaluation on Amount of Dropped Sample Fluid

The test preprocessing container nozzle 10 including the filter was connected to the test preprocessing container 20 containing the sample fluid prepared in the above process, i.e., 2. Preparation of Sample Fluid. The user dropped the sample fluid onto the microtube, the tare weight of which was measured in advance, by applying a pressure to the tube with user's fingers. Six drops of the sample fluid were dropped. In a case where it was difficult to drop six drops due to filter clogging, the sample fluid was extracted as much as possible. The amount of six drops of the sample fluid was about 160 mg. The weight of the microtube after completion of dropping was measured, and the tare weight was subtracted from the measured weight, so that the amount of dropped sample fluid was evaluated. An evaluation criterion was adopted in which a testable minimum amount of fluid or more that was able to be tested with the test kits 1/1a was able to be dropped.

### 4. Result of Evaluation on Risk of Clogging Due to Specimen

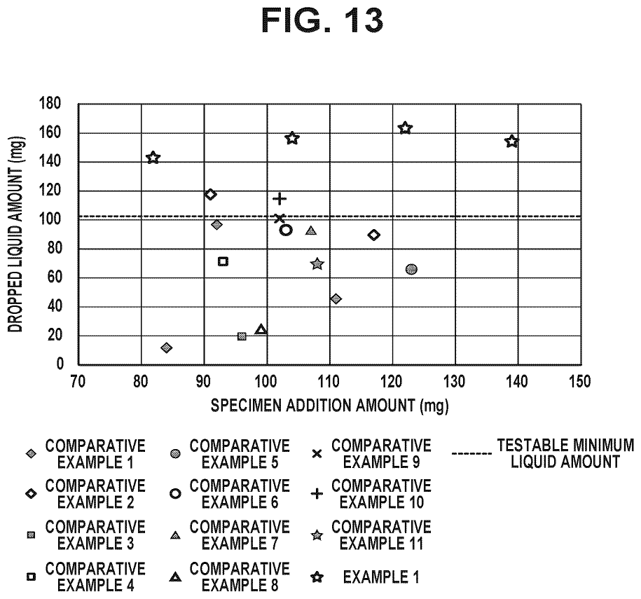

FIG. 13 is a graph illustrating results of evaluation on the risk of occurrence of clogging due to the specimen in each of the filters according to Comparative Examples 1 to 11 and Example 1. As illustrated in FIG. 13, the horizontal axis represents the amount of nasal mucosal scrapings added as the specimen (specimen addition amount) in the unit of milligrams (mg), and the vertical axis represents the amount of dropped fluid in the unit of milligrams. The amount of testable minimum fluid that is the amount of minimum required sample fluid for testing using the test kit 1/1a is indicated by a dashed line. As a result, most of the filters according to Comparative Examples 1 to 11 were unable to drop drops before the six drops because of clogging caused due to the specimen, and thus did not satisfy the amount of testable minimum fluid. In the filter according to Comparative Example 2 and the filter according to Comparative Example 10 among the filters according to Comparative Examples 1 to 11, the amount of testable minimum fluid was exceeded. However, a margin from the amount of testable minimum fluid for testing with the test kit 1/1a was small, and thus it was not sufficient. On the other hand, in the case of the filter according to Example 1, a certain amount of sample fluid was able to be dropped regardless of the addition amount of the specimen, and thus it can be said that the risk of clogging due to the specimen is small.

### [Test Example 2] Detection of Severe Acute Respiratory Syndrome (SARS) Coronavirus and Sensitivity/Specificity Evaluation

### 1. Preparation of Filters

As a filter for this test sample, the filter according to Example 1 or the filter according to Comparative Example 1 was used and the test preprocessing container nozzle 10 including each filter was prepared. In this test example, the test preprocessing container nozzle 10 included the reagent retaining part 14 disposed closer to the nozzle part 113 than the filter in the nozzle body 11. The reagent retaining part 14 retains a reagent for detecting SARS coronavirus.

### 2. Preparation of Sample Fluid

A specimen processing liquid that did not contain an antigen protein was prepared as a negative specimen, and a specimen processing liquid obtained by adding a purified SARS coronavirus antigenic protein was prepared as a positive specimen. In addition, a nasal mucosa specimen was collected from a SARS coronavirus negative subject with a brush-like swab, and a “negative nasal mucosa specimen” and a “positive nasal mucosa specimen” were prepared by adding the nasal mucosa specimen to each of the negative specimen and the positive specimen. In this case, the nasal mucosa specimen corresponding to two brush swabs were collected from the subject, and the brush swabs were allocated to the filter according to Example 1 and the filter according to Comparative Example 1. Further, the amount of the nasal mucosa specimen to be added to the sample fluid to be used in combination with the test preprocessing container nozzle 10 using the filter according to Comparative Example 1 was adjusted to the amount at which clogging did not occur.

### 3. Evaluation of Effects on Sensitivity/Specificity

The sample fluid prepared in the above process, i.e., 2. Preparation of Sample Fluid, in Test Example 2 was dropped onto the test device 30 through the test preprocessing container nozzle 10 prepared in the above process, i.e., 1. Preparation of Filters, and then sensitivity/specificity was evaluated. In this test example, the amount of a substance to be detected in a solution was detected as an optical change using an optical sensor including an optical waveguide layer. However, the detection method is not limited to this example. Various immunoassay methods. such as an immune aggregation method and an immuno-membrane assay method. may be used as the detection method.

### 4. Sensitivity/Specificity Evaluation Results

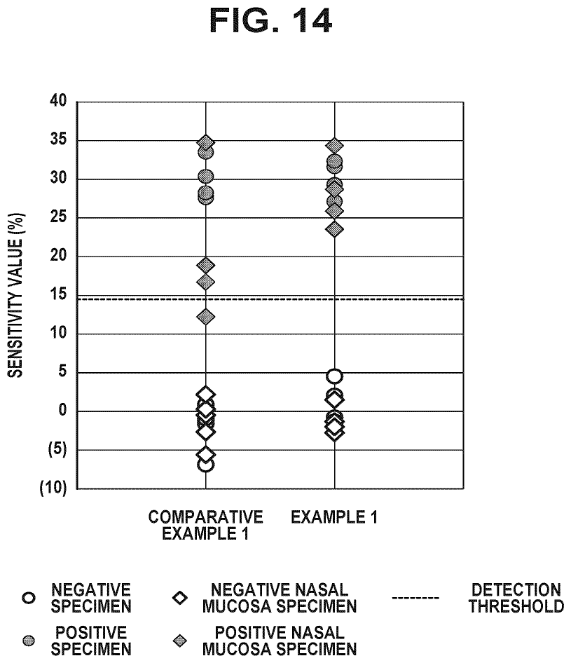

FIG. 14 is a graph illustrating sensitivity/specificity evaluation results. As seen from the graph of FIG. 14, it has turned out that, under a condition in which no nasal mucosa specimen is added, the sensitivity and the specificity were satisfactory in either one of the filter according to Example 1 and the filter according to Comparative Example 1. However, under a condition in which a nasal mucosa specimen was added, in the filter according to Comparative Example 1, the sensitivity has been deteriorated under the presence of SARS coronavirus antigenic protein. If, for example, a sensitivity value 15% was set as a detection threshold, the specificity has been also deteriorated (false negative in this case). On the other hand, in the filter according to Example 1, the sensitivity value has not been significantly decreased even under the condition in which the nasal mucosa specimen was added, and thus it can be said that the filter had no effect on the sensitivity/specificity. The results of Test Example 1 and Test Example 2 show that the use of the filter according to Example 1 makes it possible to achieve filtration of a specimen sample without deterioration of the sensitivity or while deterioration in the sensitivity is suppressed. Further, the filter according to Example 1 is capable of eliminating substances in the specimen sample that may cause a false positive reaction and a false negative reaction, whereby the false positive reaction and the false negative reaction are able to be prevented.

### [Test Example 3] Evaluation on Risk of Clogging Due to Specimen in High-Porosity Filter

The above-described first to third embodiments may desirably have a higher porosity as a factor for enabling elimination of substances in the sample that may cause a false positive reaction and a false negative reaction, without causing clogging even when the sample fluid containing nasal mucosa as the specimen is filtered. The term “high-porosity” used herein refers to a porosity of 70% or more.

### 1. Evaluation on Risk of Clogging Due to Specimen in High-Porosity Filter

An evaluation on the risk of clogging due to a specimen was made on the filters illustrated in Table 2 having a porosity similar to that of the filter according to Example 1 in accordance with the method of Test Example 1.

TABLE 2

| | Comparative | | | | | | | |
|---|---|---|---|---|---|---|---|---|
| | Example 1 | | Example 1 | | Example 2 | | Example 3 | |
| Material | Cellulose | | Polyvinyl | | Urethan | | Polyethylene | |
| | | | alcohol | | | | | |
| Porosity | — | | 89% | | 83% | | 74% | |
| (catalog | | | | | | | | |
| value) | | | | | | | | |
| Pore | 4 | μm | 80 | μm | 25 | μm | 25 | μm |
| diameter | | | | | | | | |
| Film | 2.0 | mm | 2.0 | mm | 2.0 | mm | 2.0 | mm |
| thickness | | | | | | | | |

| | Example 4 | | Example 5 | Example 6 |
|---|---|---|---|---|
| Material | Ethylene/ | | Poly- | Poly- |
| | polymer | | urethan | urethan |
| Porosity | 82% | | 85% | 80% |
| (catalog | | | | |
| value) | | | | |
| Pore | 25 | μm | 30 μm to | 40 μm to |
| diameter | | | 600 μm | 100 μm |
| Film | 2.0 | mm | 2.0 mm | 2.0 mm |
| thickness | | | | |

### 2. Results of Evaluation on Risk of Clogging Due to Specimen

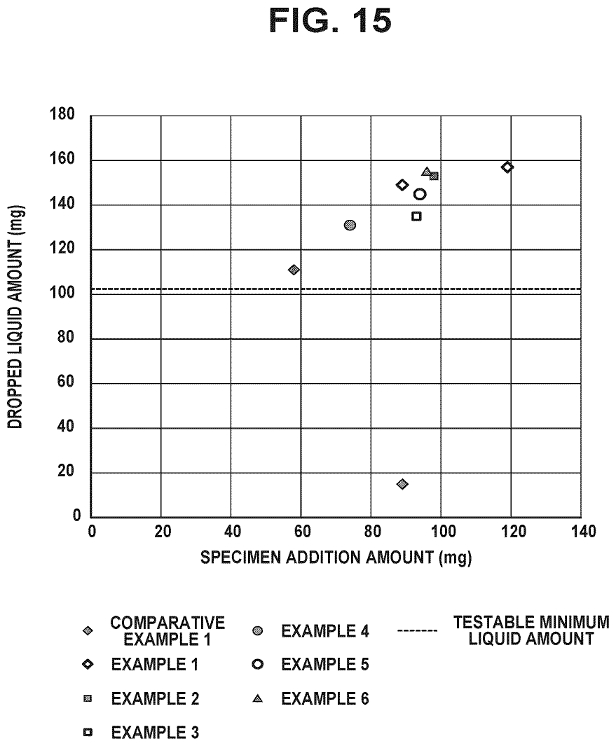

FIG. 15 is a graph illustrating results of evaluation on the risk of clogging due to the specimen in each filter. In FIG. 15, the horizontal axis represents the amount of nasal mucosal scrapings added as the specimen (specimen addition amount), and the vertical axis represents the amount of dropped fluid. In FIG. 15, the amount of testable minimum fluid that is the amount of minimum required sample fluid for testing with the test kit is indicated by a dashed line. As illustrated in FIG. 15, at the specimen addition amount at which clogging occurred due to the specimen in the filter according to Comparative Example 1 (the amount of dropped fluid is smaller than or approximate to the amount of testable minimum fluid), clogging did not occur due to the specimen in the filters according to Examples 1 to 6. Therefore, it can be said that the filters according to Examples 1 to 6 are capable of dropping a certain amount of sample fluid and the risk of clogging due to the specimen is small.

### [Test Example 4] Analysis of Risk of Clogging Due to Specimen and Porosity

A relationship between the risk of clogging due to the specimen and the porosity of the filters according to Examples 1 to 6 and the filter according to Comparative Example 1 in which clogging occurred due to the specimen was analyzed. The porosity of the filter according to Comparative Example 1 in which clogging occurred due to the specimen is not disclosed. Thus, the porosity of the filter according to Comparative Example 1 was calculated to compare and evaluate the filter according to Comparative Example 1 with the filters according to Examples 1 to 6.

### 1. Calculation of Porosity

A heavy load was placed on the filter to apply a uniform pressure (17.6 MPa) in the same direction as the direction in which the sample fluid is filtered, to squeeze the filter. In the processing, the film thickness of the filter before and after the application of the pressure was measured. A change rate of the film thickness before and after the application of the pressure was calculated based on the measured value. The change rate of the film thickness before and after the application of the pressure is dependent on a void content (porosity) within the filter, and thus that the change rate of the film thickness before and after the application of the pressure is considered to be almost equal (≈) to the porosity. Three filters were measured at once for each type of filters, and average values were calculated.

### 2. Results of Evaluation on Porosity

Table 3 illustrates results of calculation of the porosity of each of the filter according to Comparative Example 1 and the filters according to Examples 1 to 6. The results show that the porosities calculated in this test example for the filters according to Examples 1 to 6 whose porosities are disclosed as catalog values were approximate to the catalog values. Therefore, it was determined that the porosity calculation method according to this test example was appropriate. In view of this, the porosity of the filter according to Comparative Example 1 in which clogging occurred due to the specimen was 59.8%, and the minimum porosity of the filters according to Examples 1 to 6 in which the risk of clogging due to the specimen is small was 75.4%. Therefore, it may be desirable for the filter to have a porosity of 70% or more to prevent the risk of clogging due to the specimen. In other words, the results of Test Examples 1 to 4 show that when the filter has a porosity of 70% or more, filtration of a specimen sample can be achieved without deterioration of the sensitivity or while deterioration in the sensitivity is suppressed.

TABLE 3

| Comparative Example 1 | | | | | | |
|---|---|---|---|---|---|---|
| | Film thickness | Film thickness | | Change | | Catalog |
| | before pressure | after pressure | Change | rate ≈ | Average | value |
| | application | application | amount | porosity | porosity | Porosity |
| No | (mm) | (mm) | (mm) | (%) | (%) | (%) |
| 1 | 2.18 | 0.79 | 1.39 | 63.80 | 59.8 | — |
| 2 | 2.25 | 0.94 | 1.31 | 58.20 | | |
| 3 | 2.13 | 0.91 | 1.22 | 57.30 | | |
| Example 1 | | | | | | |
| | Film thickness | Film thickness | | Change | | Catalog |
| | before pressure | after pressure | Change | rate ≈ | Average | value |
| | application | application | amount | porosity | porosity | Porosity |
| No | (mm) | (mm) | (mm) | (%) | (%) | (%) |
| 1 | 1.98 | 0.43 | 1.55 | 78.3 | 76.6 | 89 |
| 2 | 1.98 | 0.46 | 1.52 | 76.8 | | |
| 3 | 1.99 | 0.5 | 1.49 | 74.9 | | |
| Example 2 | | | | | | |
| | Film thickness | Film thickness | | Change | | Catalog |
| | before pressure | after pressure | Change | rate ≈ | Average | value |
| | application | application | amount | porosity | porosity | Porosity |
| No | (mm) | (mm) | (mm) | (%) | (%) | (%) |
| 1 | 2.06 | 0.34 | 1.72 | 83.5 | 83.4 | 83 |
| 2 | 2.06 | 0.36 | 1.7 | 82.5 | | |
| 3 | 2.07 | 0.33 | 1.74 | 84.1 | | |
| Example 3 | | | | | | |
| | Film thickness | Film thickness | | Change | | Catalog |
| | before pressure | after pressure | Change | rate ≈ | Average | value |
| | application | application | amount | porosity | porosity | Porosity |
| No | (mm) | (mm) | (mm) | (%) | (%) | (%) |
| 1 | 2.08 | 2.74 | 1.48 | 71.2 | 75.4 | 74 |
| 2 | 2.09 | 2.59 | 1.64 | 78.5 | | |
| 3 | 2.04 | 2.62 | 1.56 | 76.5 | | |
| Example 4 | | | | | | |
| | Film thickness | Film thickness | | Change | | Catalog |
| | before pressure | after pressure | Change | rate ≈ | Average | value |
| | application | application | amount | porosity | porosity | Porosity |
| No | (mm) | (mm) | (mm) | (%) | (%) | (%) |
| 1 | 2.04 | 0.41 | 1.63 | 79.9 | 81.8 | 82 |
| 2 | 2.03 | 0.39 | 1.64 | 80.8 | | |
| 3 | 2.03 | 0.31 | 1.72 | 84.7 | | |
| Example 5 | | | | | | |
| | Film thickness | Film thickness | | Change | | Catalog |
| | before pressure | after pressure | Change | rate ≈ | Average | value |
| | application | application | amount | porosity | porosity | Porosity |
| No | (mm) | (mm) | (mm) | (%) | (%) | (%) |
| 1 | 2.02 | 0.21 | 1.81 | 89.6 | 90.2 | 85 |
| 2 | 2.04 | 0.20 | 1.84 | 90.2 | | |
| 3 | 2.07 | 0.19 | 1.88 | 90.8 | | |
| Example 6 | | | | | | |
| | Film thickness | Film thickness | | Change | | Catalog |
| | before pressure | after pressure | Change | rate ≈ | Average | value |
| | application | application | amount | porosity | porosity | Porosity |
| No | (mm) | (mm) | (mm) | (%) | (%) | (%) |
| 1 | 2.00 | 0.40 | 1.60 | 80.0 | 80.7 | 80 |
| 2 | 2.02 | 0.42 | 1.60 | 79.2 | | |
| 3 | 2.04 | 0.35 | 1.69 | 82.8 | | |

### [Test Example 5] Analysis of High Porosity and Flexibility

Flexibility for enabling a high-porosity filter to be flexibly deformed against an inflow pressure of a sample is required to maintain a filter structure for filtering a sample fluid in the high-porosity filter. For this reason, a pressure of about 0.2 MPa was set as a pressure applied from a fluid or air when the sample fluid was filtered, the flexibility of the filters according to Examples 1 to 6 was evaluated based on the change rate of the film thickness before and after the filtration.

### 1. Calculation of Flexibility

The film thickness of each filter to be evaluated was measured in advance with a micrometer. An evaluation of the flexibility was made during filtration of a sample fluid, thus various filters were immersed in the specimen processing liquid SPL for five minutes. After that, a digital force gauge (manufacturer: IMADA, model number: DST-20N) was used to apply a pressure of 0.2 MPa in the same direction as the direction in which the sample fluid was filtered. The film thickness after the application of the pressure was measured with a micrometer, and the flexibility during filtration of the sample fluid was evaluated based on the change rate of the film thickness before and after the application of the pressure. Three filters were measured at once for each type of filters, and average values were calculated.

### 2. Results of Evaluation on Flexibility

Table 4 illustrates results of calculation of the flexibility of the filters according to Examples 1 to 6. With respect to the pressure of 0.2 MPa applied during filtration of a sample fluid, the change rate of the film thickness of the filters according to Examples 1 to 6 before and after the application of the pressure was 22.5% to 78.3%. Accordingly, it may be desirable for a high-porosity filter having a porosity of 70% or more to have flexibility with a film thickness change rate of 20% or more with respect to the pressure of 0.2 MPa applied during filtration of the sample fluid. Further, the filter having flexibility of 20% or more can be easily processed and has a higher degree of freedom of press-fitting into a minute flow channel.

TABLE 4

| | | | | | |
|---|---|---|---|---|---|
| | | | | Film | Average |
| | Film thickness | Film thickness | | thickness | film |
| | before pressure | after pressure | Change | change | thickness |
| | application | application | amount | rate | change |
| No | (mm) | (mm) | (mm) | (%) | rate |

Example 1

| | | | | | |
|---|---|---|---|---|---|
| 1 | 1.99 | 1.68 | 0.31 | 15.6 | 22.5 |
| 2 | 1.94 | 1.27 | 0.67 | 34.5 | |
| 3 | 2 | 1.65 | 0.35 | 17.5 | |

Example 2

| | | | | | |
|---|---|---|---|---|---|
| 1 | 2.11 | 0.41 | 1.7 | 80.6 | 75.2 |
| 2 | 2.09 | 0.64 | 1.45 | 69.4 | |
| 3 | 2.09 | 0.51 | 1.58 | 75.6 | |

Example 3

| | | | | | |
|---|---|---|---|---|---|
| 1 | 2.03 | 1.42 | 0.61 | 30 | 25.4 |
| 2 | 2.04 | 1.52 | 0.52 | 25.5 | |
| 3 | 2.02 | 1.6 | 0.42 | 20.8 | |

Example 4

| | | | | | |
|---|---|---|---|---|---|
| 1 | 2.12 | 0.9 | 1.22 | 57.5 | 63.7 |
| 2 | 2.14 | 0.67 | 1.47 | 68.7 | |
| 3 | 2.13 | 0.75 | 1.38 | 64.8 | |

Example 5

| | | | | | |
|---|---|---|---|---|---|
| 1 | 1.97 | 0.62 | 1.35 | 68.5 | 78.3 |
| 2 | 1.95 | 0.30 | 1.65 | 84.6 | |
| 3 | 1.96 | 0.36 | 1.6 | 81.6 | |

Example 6

| | | | | | |
|---|---|---|---|---|---|
| 1 | 2.10 | 0.39 | 1.71 | 81.4 | 77.2 |
| 2 | 2.07 | 0.59 | 1.48 | 71.5 | |
| 3 | 2.06 | 0.44 | 1.62 | 78.6 | |

### [Test Example 6] Analysis of Risk of Clogging Due to Specimen and Filter Film Thickness

A relationship between the film thickness of each filter and the risk of clogging due to the specimen in the filter according to Comparative Example 1 and the filter according to Example 1 was evaluated.

### 1. Preparation of Filters

The filter according to Example 1 and the filter according to Comparative Example 1 in which clogging occurred due to the specimen were prepared by the method in accordance with the above process, i. e., 1. Preparation of Filters, in Test Example 1 by forming each film with a film thickness of 1 mm to 5 mm.

### 2. Evaluation on Risk of Clogging Due to Specimen

An evaluation was made in accordance with Test Example 1.

### 3. Results of Evaluation on Risk of Clogging Due to Specimen

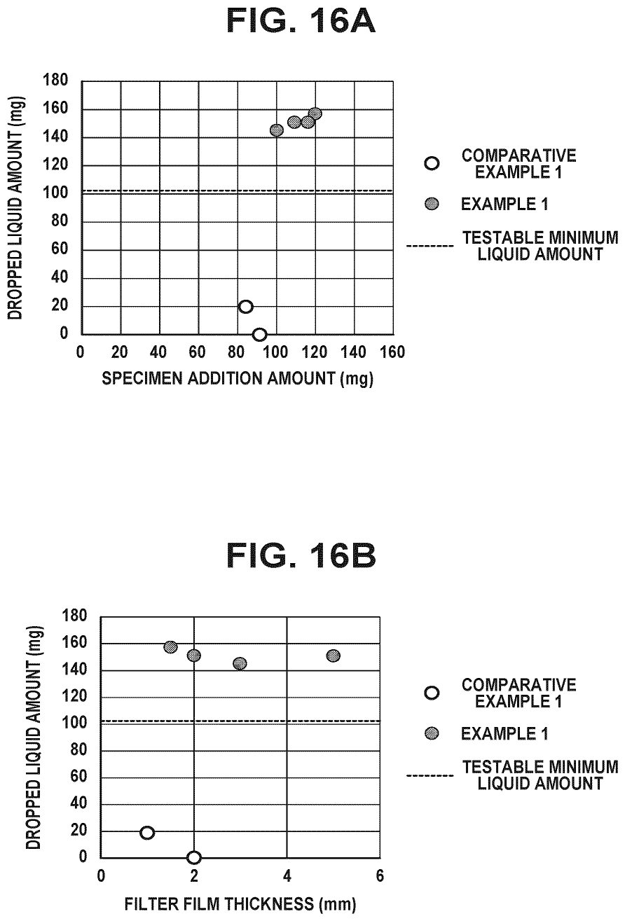

FIGS. 16A and 16B are graphs each illustrating results of evaluation on the film thickness of each filter and the risk of occurrence of clogging due to the specimen. In FIG. 16A, the horizontal axis represents the amount of nasal mucosal scrapings added as the specimen (specimen addition amount), and the vertical axis represents the amount of dropped fluid. The results show that in the filter according to Comparative Example 1, clogging due to the specimen occurred at a specimen addition amount of about 90 mg, while in the filter according to Example 1, the specimen addition amount was more than 90 mg. In FIG. 16B, the horizontal axis represents the film thickness of each filter, and the vertical axis represents the amount of dropped fluid. In the filter according to Example 1, clogging due to the specimen did not occur at a film thickness in a range from 1.5 mm to 5 mm even in the case where the amount of the specimen more than or equal to the specimen addition amount at which clogging due to the specimen occurred in the filter according to Comparative Example 1 was added, so that the filter according to Example 1 was able to drop a certain amount of sample fluid.

According to at least one of the embodiments described above, filtration of a specimen sample is achieved without deteriorating the sensitivity or while deterioration in the sensitivity is suppressed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A test preprocessing container nozzle comprising:
a nozzle body configured to include a connected part and a nozzle part provided to the connected part, the connected part being connected to a test preprocessing container containing a specimen collected from a patient and a specimen processing liquid, which is a processing liquid for the specimen, the nozzle part having a communicating hole to deliver a fluid contained in the test preprocessing container; and
a filter disposed in the nozzle body and configured to filter the fluid,
wherein the filter has a porosity of 70 percent (%) to 95%.

2. The test preprocessing container nozzle according to claim 1, wherein the filter has a pore diameter of 25 micrometers (μm) to 600 μm.

3. The test preprocessing container nozzle according to claim 1, wherein in a case where a pressure of 0.2 megapascals (MPa) is applied to the filter, a change rate of a film thickness of the filter before and after the application of the pressure is more than or equal to 15%.

4. The test preprocessing container nozzle according to claim 2, wherein in a case where a pressure of 0.2 MPa is applied to the filter, a change rate of a film thickness of the filter before and after the application of the pressure is more than or equal to 15%.

5. The test preprocessing container nozzle according to claim 1, wherein the filter has a film thickness of 1 mm to 5 mm.

6. The test preprocessing container nozzle according to claim 1, wherein the filter is configured to capture impurities in the specimen on a surface of the filter and even on an inside of the filter.

7. The test preprocessing container nozzle according to claim 1, wherein the filter is a sponge-like structure having a structure in which pores are developed into a network form.

8. The test preprocessing container nozzle according to claim 1, wherein the specimen is at least one of pharyngeal swab, nasal swab, nasopharyngeal swab, nasal aspirate fluid, nasal lavage fluid, alveolar lavage fluid, blood, fecal suspension, and rectal swab collected from a human or other animals.

9. The test preprocessing container nozzle according to claim 1, wherein the filter retains a reagent containing a substance bindable to a substance to be detected in the specimen.

10. The test preprocessing container nozzle according to claim 1, further comprising a reagent retaining part configured to retain a reagent containing a substance bindable to a substance to be detected in the specimen.

11. The test preprocessing container nozzle according to claim 10, wherein the reagent retaining part has a porous structure formed with a plurality of pores.

12. The test preprocessing container nozzle according to claim 1, further comprising an anti-falling member configured to prevent the filter from falling.

13. The test preprocessing container nozzle according to claim 1, wherein the connected part is connected to the test preprocessing container by fastening the connected part to the test preprocessing container by screwing.

14. A test kit comprising:
a test preprocessing container nozzle according to claim 1;
a test preprocessing container configured to be connectable to the test preprocessing container nozzle and deformable by application of a pressure, the test preprocessing container containing a specimen processing liquid, which is a processing liquid for the specimen;
a test device configured to detect or quantify a substance to be detected in the specimen; and
a specimen collection tool configured to collect the specimen from the patient.

15. A specimen processing method that uses:
a test preprocessing container nozzle according to claim 1;
a test preprocessing container configured to be connectable to the test preprocessing container nozzle and deformable by application of a pressure, the test preprocessing container containing a specimen processing liquid, which is a processing liquid for the specimen; and
a specimen collection tool configured to collect the specimen from the patient,
the specimen processing method comprising:
collecting a specimen using the specimen collection tool;
introducing the specimen collected using the specimen collection tool into the test preprocessing container;
connecting the test preprocessing container nozzle to the test preprocessing container; and
applying a pressure to the test preprocessing container to drop a fluid contained in the test preprocessing container by using the filter.
